(19) United States
(12) Patent Application Publication
(10) Pub. No.: US 2026/0270656 A1
(43) Pub. Date: Sep. 10, 2026

(54) ADAPTIVE DATA RATES FOR PUSH-TO-TALK TRANSMISSIONS

(71) Applicant: MOTOROLA SOLUTIONS, INC., Chicago, IL (US)

(72) Inventors: Harvey D. Chambers, Sunrise, FL (US); Cesar D. Aguilar, Weston, FL (US); Daniel J. McDonald, Elkhorn, WI (US)

(21) Appl. No.: 19/074,056

(22) Filed: Mar. 7, 2025

(51) Int. Cl. H04W 4/10; H04L 1/00; H04L 1/20; H04W 28/22

(52) U.S. Cl. CPC H04W 4/10; H04L 1/0002; H04L 1/0009; H04L 1/0033; H04L 1/203; H04W 28/22

(57) ABSTRACT

Examples described herein provide adaptive data rates for push-to-talk transmissions. One example provides a fixed network device that communicates with push-to-talk portable electronic devices via a communication network. The fixed network device comprises an electronic processor configured to, for each push-to-talk transmission of the portable electronic devices, receive a push-to-talk transmission request from a first portable electronic device, determine a set of the portable electronic devices within a talkgroup participating in the requested push-to-talk transmission, determine, based on a characteristic of the talkgroup, a vocoder data rate and a forward error correction coding data rate for the requested push-to-talk transmission, and transmit the determined vocoder data rate and the determined forward error correction coding data rate to the set of portable electronic devices within the talkgroup.

### BACKGROUND

Public safety agencies use portable communications devices (for example, land mobile radios) to facilitate communication between their personnel (for example, first responders) while responding to incidents. To streamline communication, personnel are often assigned to different communication groups. In many cases, these communication groups are “talkgroups.” When responding to a public safety incident, first responders may utilize many resources and require communications with personnel participating in multiple talkgroups.

Audio quality is also important to first responder communications. Audio quality performance of devices communicating within talkgroups is often based on the radio channel data capacity. Current land mobile radio channel data rates are within the range of 2.45 to 4.4 kbps before forward error correction is performed. These channel bandwidth allocations for audio transmission and error correction are preset regardless of coverage conditions.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed subject matter, and explain various principles and advantages of those examples.

FIG. 1 is a block diagram of a communication system according to some aspects.

FIG. 2 is a diagram of a communication device included in the communication system of FIG. 1 according to some aspects.

FIG. 3 is a diagram of a fixed network equipment included in the communication system of FIG. 1 according to some aspects.

FIG. 4 is a flowchart of adapting data rates for push-to-talk transmissions according to some aspects.

FIG. 5 is a flowchart of a method of adapting data rates for push-to-talk transmissions outside of a push-to-talk transmission according to some aspects.

FIG. 6 is a flowchart of a method of adapting data rates for push-to-talk transmissions during a push-to-talk transmission according to some aspects.

FIG. 7 is a flowchart of a method of adapting data rates for push-to-talk transmissions based on channel condition information according to some aspects.

FIG. 8 is a flowchart of a method of adapting data rates for push-to-talk transmissions based on audio quality according to some aspects.

FIGS. 9A-9C are flowcharts of a method of adapting data rates for push-to-talk transmissions within a talkgroup according to some aspects.

FIG. 10 is a diagram of a geofence within in which some communication devices are situated according to some aspects.

FIG. 11 is a flowchart of a method of adapting data rates for push-to-talk transmissions based on a priority of communication devices according to some aspects.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, features, and aspects illustrated.

The apparatus and method components have been represented where appropriate by conventional symbols in the drawings, showing only those specific details that are pertinent to understanding the examples, features, and aspects so as not to obscure the disclosure with details that will be readily apparent to those of ordinary skill in the art having the benefit of the description herein.

### DETAILED DESCRIPTION

Push-to-talk is a communication technique where a user presses a dedicated button (physical or virtual) on a device to speak with another person. In a push-to-talk mode, the device acts similar to a walkie-talkie, allowing only one person to transmit at a time until the button is released. Push-to-talk enables quick and immediate communication with others. Activating a push-to-talk button switches a device between a voice transmission mode to a voice reception mode and is commonly used in land mobile radio communications. More recently, push-to-talk techniques have been adopted in broadband communications. In broadband communications, a wideband codec adapted, for example, for Long Term Evolution (LTE) or similar protocols, may be used to improve audio quality.

However, many existing communication devices are locked into traditional land mobile radio (LMR) architectures. Traditional LMR communication is limited to narrowband audio, and current LMR radio channel data rates and vocoders cannot provide wideband audio due to the low-bit rates available. These traditional LMR communication data rates may be within the range of 2.45 to 4.4 kbps before Forward Error Correction (FEC) is implemented. The channel bandwidth allocations for audio and FEC is defined and preset. Accordingly, even in areas with relatively strong coverage conditions (described in more detail below) where lower amounts of FEC is necessary, data allocations are traditionally constant.

Examples described herein provide, among other things, systems and methods for dynamically adjusting data rates between audio codecs and FEC within a channel data rate budget that is based on talkgroup channel condition information. For example, when relatively strong coverage is available, the FEC data rate may be reduced to increase the data rate for the audio itself.

In some instances, communication devices described herein transmit channel condition information, such as coverage information, to fixed network equipment, such as a server. The channel condition information may include a bit error rate (BER), a received signal strength indicator (RSSI), a speech signal-to-noise ratio (SNR), or the like. The channel condition information may be transmitted at the initiation of each push-to-talk transmission (for example, when transmitting or receiving audio), or may be transmitted outside of push-to-talk transmission (for example, when in an idle mode). The fixed network equipment may then identify a vocoder data rate for the audio and an error correction data rate for error correction for the push-to-talk transmission.

Examples presented herein offer, among other things, advantages over prior systems and techniques by increasing audio quality when less error correction is necessary, while also utilizing existing LMR architecture. Data rates are dynamically adjusted during operation of communication devices such that each push-to-talk transmission includes the best audio data rate available with little or no delay in user communication.

One example provides a fixed network device that communicates with push-to-talk portable electronic devices via a communication network. The fixed network device comprises an electronic processor configured to, for each push-to-talk transmission of the portable electronic devices, receive a push-to-talk transmission request from a first portable electronic device, determine a set of the portable electronic devices within a talkgroup participating in the requested push-to-talk transmission, determine, based on a characteristic of the talkgroup, a vocoder data rate and a forward error correction coding data rate for the requested push-to-talk transmission, and transmit the determined vocoder data rate and the determined forward error correction coding data rate to the set of portable electronic devices within the talkgroup.

Another example provides a method for adapting data rates for push-to-talk transmissions. The method includes, for each push-to-talk transmission, receiving a push-to-talk transmission request from a first portable electronic device, determining a set of portable electronic devices within a talkgroup participating in the requested push-to-talk transmission, determining, based on a characteristic of the talkgroup, a vocoder data rate and a forward error correction coding data rate for the requested push-to-talk transmission, and transmitting the determined vocoder data rate and the determined forward error correction coding data rate to the set of portable electronic devices within the talkgroup.

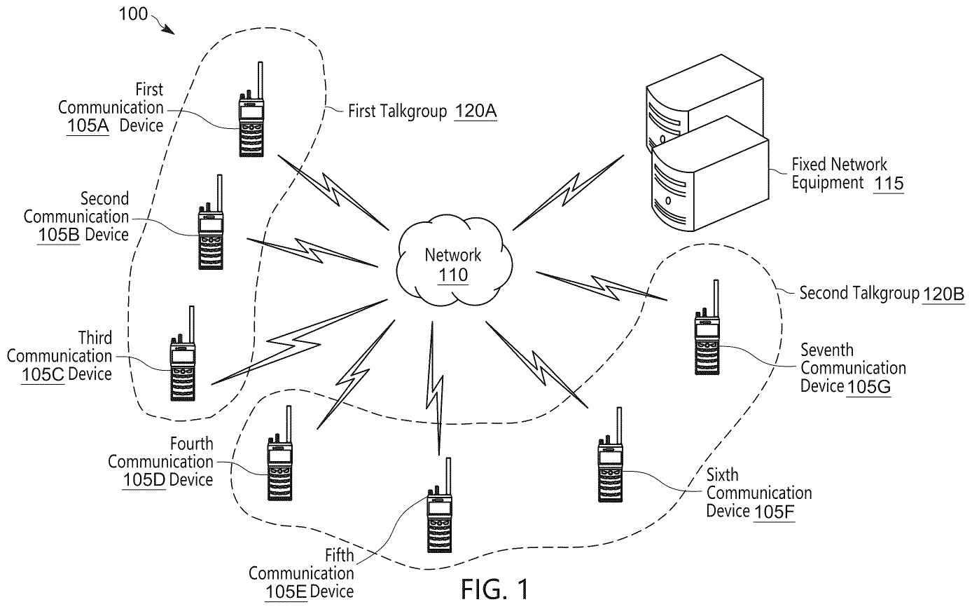

FIG. 1 is a diagram of a communication system 100 according to one example. In the example shown, the communication system 100 includes a plurality of portable communication devices. In the example illustrated in FIG. 1, a first communication device 105A, a second communication device 105B, a third communication device 105C, a fourth communication device 105D, a fifth communication device 105E, a sixth communication device 105F, and a seventh communication device 105G are shown. In the following description, when explaining how a single communication device functions, a reference to communication device 105 is used. And, when referring to communication device 105, it is generally intended that the description apply equally to all the communications device 105A-105G. It is not necessary, however, that the communication devices 105A through 105G be identical. The communication devices 105A through 105G are merely examples. In some embodiments, the communication systems may include more or fewer communication devices than the number shown in communication system 100 illustrated in FIG. 1.

In the example illustrated, the communication devices 105A through 105G communicate with each other over a network 110. Parts of the network 110 are wireless, but some parts of the network 110 may be a wired. All or parts of the network 110 may be implemented using various existing networks, for example, a cellular network, a Long Term Evolution (LTE) network, a 3GPP compliant network, a 5G network, the Internet, a land mobile radio (LMR) network, a Bluetooth™ network, a wireless local area network (for example, Wi-Fi), a wireless accessory Personal Area Network (PAN), a Machine-to-machine (M2M) autonomous network, radio frequency transmission components (for example, radio frequency sites), and a public switched telephone network. The network 110 may also include future developed networks. In some examples, the network 110 may also include a combination of the networks mentioned previously herein. In some examples, the communication devices 105A through 105G may communicate directly with each other using a communication channel or connection that is outside of the network 110. For example, the plurality of communication devices 105A through 105G may communicate directly with each other when they are within a predetermined distance from each other.

In some examples, the communication system 100 also includes a fixed network equipment 115 (e.g., a server or another fixed network device) that monitors the communication devices 105A through 105G. In some examples, the fixed network equipment 115 is a computer maintained, for example, at a call center or public safety command center.

In some examples, the communication devices 105A through 105G are configured in talkgroups. A talkgroup may define a group of communication devices that may be collectively referenced during push-to-talk transmissions. For example, the first communication device 105A, the second communication device 105B, and the third communication device 105C may be in a first talkgroup 120A. The fourth communication device 105D, the fifth communication device 105E, the sixth communication device 105F, and the seventh communication device 105G may be in a second talkgroup 120B. In the following description, when explaining how a single talkgroup functions, a reference to talkgroup 120 is used.

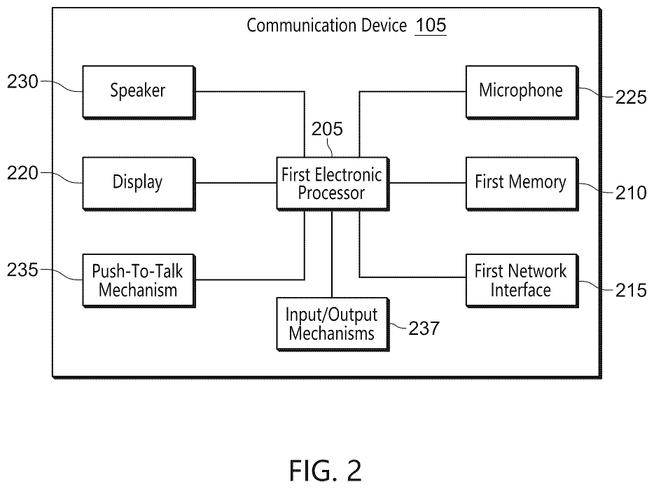

FIG. 2 is a block diagram of a communication device 105 of the communication system 100 according to one example. In the example shown, the communication device 105 includes a first electronic processor 205 (for example, a microprocessor or another electronic device). The first electronic processor 205 may be electrically connected to a first memory 210, a first network interface 215, a display 220, a microphone 225, a speaker 230, a push-to-talk mechanism 235, and other input and output mechanisms 237. In some examples, the communication device 105 may include fewer or additional components in configurations different from that illustrated in FIG. 2. For example, in some examples, the communication device 105 also includes a camera and a location component (for example, a global positioning system receiver). In some examples, the communication device 105 performs additional functionality than the functionality described below.

The first memory 210 includes read only memory (ROM), random access memory (RAM), other non-transitory computer-readable media, or a combination thereof. The first electronic processor 205 is configured to receive instructions and data from the first memory 210 and execute, among other things, the instructions. In particular, the first electronic processor 205 executes instructions stored in the first memory 210 to perform the methods described herein.

The first network interface 215 sends and receives data to and from the network 110. For example, the first network interface 215 may include a transceiver for wirelessly communicating with the network 110. Alternatively or in addition, the first network interface 215 may include a connector or port to establish a wired connection to the network 110. The wired connection may be created, for example, via an Ethernet cable. The first electronic processor 205 receives electrical signals representing sound from the microphone 225 and may communicate information related to the electrical signals over the network 110 through the first network interface 215. The information may be intended for receipt by another communication device 105. Similarly, the first electronic processor 205 may output data received from the network 110 through the first network interface 215, for example, as from another communication device 105, through the speaker 230, the display 220, or a combination thereof.

In some examples, the push-to-talk mechanism 235 allows a user of the communication device 105 to initiate communication over the network 110. For example, when the first electronic processor 205 detects that the push-to-talk mechanism 235 is enabled, the first electronic processor 205 receives a signal from the microphone 225 of detected sound and send data representing that sound (referred to hereafter as voice data) over the network 110 (for example, as a half-duplex communication signal). In some examples, the voice data is communicated to other communication devices that are affiliated with a talkgroup 120 to which the communication device 105 is broadcasting. When the first electronic processor 205 detects that the push-to-talk mechanism 235 is no longer enabled (for example, has been released), the first electronic processor 205 stops the communication of the voice data. In some examples, the push-to-talk mechanism 235 may be a mechanical button or knob or a virtual button or knob displayed on the display 220, which may include a touchscreen. In some examples, the push-to-talk mechanism 235 may be a mechanical button or knob on an accessory that is separate from and communicates with the communication device 105 (for example, a button or knob on a remote speaker-microphone, or a wireless connected button, such as a Bluetooth® connected button).

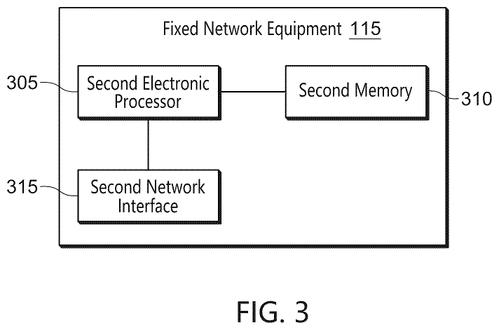

FIG. 3 is a block diagram of the fixed network equipment 115 according to one example. In the example illustrated, the fixed network equipment 115 is a computer that includes a second electronic processor 305, an input/output interface (not shown), a second memory 310, and a second network interface 315. These components are similar to those described above with respect to the communication device 105 and perform similar functions, but need not be identical. As noted previously herein, in some examples, the fixed network equipment 115 monitors the communication devices 105 by receiving channel condition information associated with the communication devices 105 (for example, BER, RSSI, location information, and the like) from the communication devices 105 through the second network interface 315. In some examples, channel condition information from the communication devices 105 are stored in the second memory 310 by the second electronic processor 305.

In some examples, at least some of the information described above as being stored by the second memory 310 (for example, channel condition information from the communication devices 105) may be stored in a database or other network element that is separate from the fixed network equipment 115. In such examples, the separate database communicates with the fixed network equipment 115 over the network 110 such that the fixed network equipment 115 receives information stored in the separate database.

The communication devices 105 may periodically transmit channel condition information to the fixed network equipment 115. For each communication device 105, the communication device 105 may transmit channel condition information while idle (for example, periodically while not transmitting or receiving audio), when transmitting audio (for example, at the start of a push-to-talk transmission), or when receiving audio. In this manner, the fixed network equipment is provided channel condition information related to all communication devices 105 communicating over the network 110.

When push-to-talk transmissions are initiated (for example, when the push-to-talk mechanism 235 is pushed on a communication device 105), the fixed network equipment 115 may determine which communication devices 105 are included within a talkgroup 120 associated with a push-to-talk transmission. For example, the first communication device 105A initiates a push-to-talk transmission to the first talkgroup 120A. The fixed network equipment 115 determines which communication devices 105 are associated with the first talkgroup 120A (e.g., the first communication device 105A, the second communication device 105B, and the third communication device 105C).

Once the relevant communication devices 105 are identified, the fixed network equipment 115 determines a vocoder data rate for the audio transmission and an error correction data rate for the error correction. When the channel condition information of each communication device 105 within the talkgroup 120 indicates that SNR is high (e.g., greater than a threshold), more bandwidth is dedicated to the audio transmission and less bandwidth is dedicated to error correction. However, when SNR is low (e.g., less than a threshold), more bandwidth is dedicated to error correction and less bandwidth is dedicated to the audio transmission. The determination of data rates may further be based on the location of the communication devices 105 within the talkgroup 120, based on assigned roles or priority of the communication devices 105, and the like.

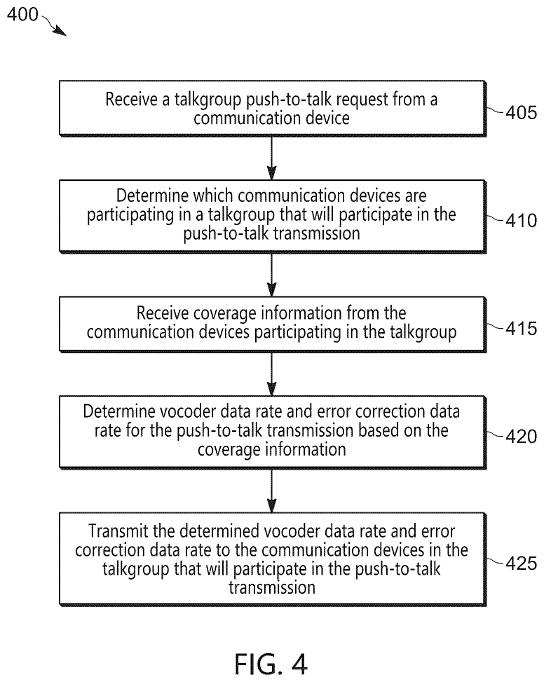

FIG. 4 illustrates an example method 400 of adapting data rates for push-to-talk transmissions. The method 400 is described as being executed by the fixed network equipment 115 and, in particular, by the second electronic processor 305. However, in some examples, the method 400 is performed by another device (for example, another computer such as a radio frequency site within the network 110 or one of the communication devices 105). Additionally, while the process blocks illustrated in FIG. 4 provide one example of a method described herein, it is understood that some blocks may be removed, added, combined, reordered, or modified without departing from the spirit of the present disclosure.

At block 405, the second electronic processor 305 receives a talkgroup push-to-talk request from a communication device 105. For example, a user of the first communication device 105A presses the push-to-talk mechanism 235 to initiate a push-to-talk transmission. In response, the communication device 105 transmits a talkgroup push-to-talk request to the fixed network equipment 115 indicating the incoming push-to-talk transmission.

At block 410, the second electronic processor 305 determines which communication devices 105 are participating in a talkgroup 120 that will participate in the push-to-talk transmission. For example, the talkgroup push-to-talk request may indicate a talkgroup 120 included in the push-to-talk transmission. The fixed network equipment 115 determines which communication devices 105 are included in the talkgroup 120.

In another example, the fixed network equipment 115 determines a talkgroup in which the requesting communication device 105 is included in. For example, the first communication device 105A transmits the talkgroup push-to-talk request to the fixed network equipment 115. The fixed network equipment 115 determines that the first communication device 105A is included in the first talkgroup 120A. The fixed network equipment 115 then determines which other devices are included in the first talkgroup 120A (for example, the second communication device 105B and the third communication device 105C).

At block 415, the second electronic processor 305 receives channel condition information from the communication devices 105 participating in the talkgroup 120. By way of example, when the first talkgroup 120A is participating in the push-to-talk transmission, the fixed network equipment 115 receives channel condition information from the first communication device 105A, the second communication device 105B and the third communication device 105C. Channel condition information may be transmitted by each communication device 105 upon initiation of the push-to-talk transmission. The channel condition information may include an RSSI metric of each communication device 105 within the talkgroup 120, a BER metric of each communication device 105 within the talkgroup 120, a location of each communication device 105 within the talkgroup 120, an assigned role or priority value of each communication device 105 within the talkgroup 120, or some other audio quality metric.

In another example, the fixed network equipment 115 receives the channel condition information from the second memory 310. For example, the communication devices 105 transmit channel condition information prior to the push-to-talk transmission or during a previous push-to-talk transmission. The fixed network equipment 115 receives the channel condition information and stores the channel condition information in the second memory 310.

In another example, the second electronic processor 305 receives channel condition information from the communication device 105 that transmits the talkgroup push-to-talk request (for example the first communication device 105A). The second electronic processor 305 then retrieves previous channel condition information associated with other communication devices 105 within the relevant talkgroup 120 from the second memory 310.

At block 420, the second electronic processor 305 determines a vocoder data rate and an error correction data rate for the push-to-talk transmission based on the channel condition information. For example, the fixed network equipment 115 sets the vocoder data rate and the error correction data rates based on a relation between the channel condition information and one or more thresholds, as described below in more detail.

At block 425, the second electronic processor 305 transmits the determined vocoder data rate and error correction data rate to the communication devices 105 in the talkgroup 120 that will participate in the push-to-talk transmission. In this manner, the vocoder data rate and error correction data rates are dynamically set to increase audio quality for the talkgroup communication while still prioritizing error correction as necessary.

The method 400 may be repeated for additional push-to-talk transmission requests. For example, the second electronic processor 305 may receive a second talkgroup push-to-talk request from the first communication device 105A. In response, the second electronic processor 305 repeats the method 400 and transmits an updated vocoder data rate and an updated error correction data rate to the communication devices 105 within the talkgroup 120.

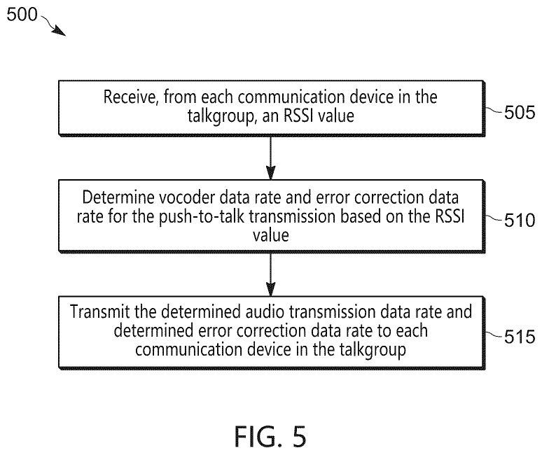

In some aspects, the fixed network equipment 115 determines vocoder and error correction data rates when the communication devices 105 are not engaging in a push-to-talk transmission. FIG. 5 illustrates an example method 500 of adapting data rates for push-to-talk transmissions based on an RSSI value of a talkgroup 120 outside of a push-to-talk transmission. The method 500 is described as being executed by the fixed network equipment 115 and, in particular, by the second electronic processor 305. However, in some examples, the method 500 is performed by another device (for example, another computer or one of the communication devices 105. Additionally, while the process blocks illustrated in FIG. 5 provide one example of a method described herein, it is understood that some blocks may be removed, added, combined, reordered, or modified without departing from the spirit of the present disclosure.

At block 505, the second electronic processor 305 receives, from each communication device 105 in a talkgroup 120, an RSSI value. In one example, each communication device 105 in the talkgroup 120 transmits a current RSSI value to the fixed network equipment 115 at the initiation of a push-to-talk transmission. In another example, each communication device 105 in the talkgroup 120 transmits a current RSSI value to the fixed network equipment 115 when a push-to-talk transmission is not occurring (for example, the communication devices 105 are in an idle state and not transmitting or receiving audio). In some instances, the second electronic processor 305 selects the lowest RSSI value associated with communication devices 105 in the talkgroup 120. In yet another instance, the second electronic processor 305 calculates an average RSSI value using the received RSSI values from each communication device 105 in the talkgroup 120.

In another example, the second electronic processor 305 receives an RSSI value from a communication device 105 that initiates the method 500 (for example, transmits a talkgroup push-to-talk request to the fixed network equipment 115). The second electronic processor 305 then retrieves previous RSSI values associated with other communication devices 105 within the relevant talkgroup 120 from the second memory 310.

At block 510, the second electronic processor 305 determines (for example, calculates or estimates) a vocoder data rate and an error correction data rate for the push-to-talk transmission based on the RSSI value from each communication device 105. For example, the second electronic processor 305 may compare the RSSI value to a look-up table stored in the second memory 310. By way of example, consider an RSSI value greater than 100. In such an instance, the second electronic processor 305 compares the RSSI value to a look-up table and selects a vocoder data rate of approximately 6 kbps with an associated, lower error correction data rate. In another example, consider an RSSI value less than 50. In such an instances, the second electronic processor 305 compares the RSSI value to a look-up table and selects a vocoder data rate of approximately 3.2 kbps with an associated, higher error correction data rate.

At block 515, the second electronic processor 305 transmits the determined vocoder data rate and the error correction data rate to each communication device 105 in the talkgroup 120. In this manner, the communication devices 105 in the talkgroup 120 utilize updated vocoder data rates and error correction data rates during a subsequent push-to-talk transmission.

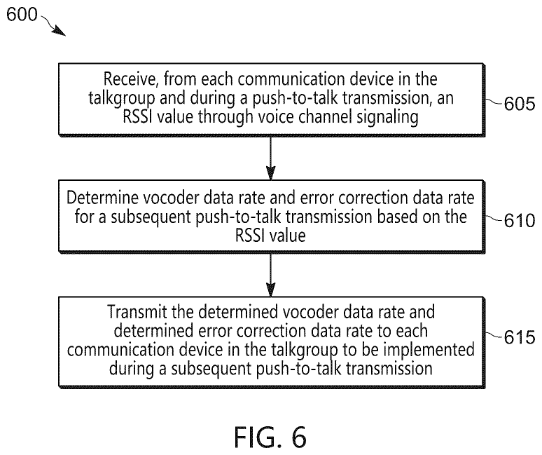

In other aspects, the fixed network equipment 115 determines vocoder and error correction data rates when the communication devices 105 are actively engaging in a push-to-talk transmission. FIG. 6 illustrates an example method 600 of adapting data rates for push-to-talk transmissions based on an RSSI value of a talkgroup 120 during a push-to-talk transmission. The method 600 is described as being executed by the fixed network equipment 115 and, in particular, by the second electronic processor 305. However, in some examples, the method 600 is performed by another device (for example, another computer or one of the communication devices 105). Additionally, while the process blocks illustrated in FIG. 6 provide one example of a method described herein, it is understood that some blocks may be removed, added, combined, reordered, or modified without departing from the spirit of the present disclosure.

At block 605, the second electronic processor 305 receives, from each communication device 105 in the talkgroup 120 and during a push-to-talk transmission, an RSSI value through voice channel signaling (e.g., common-channel signaling). For example, each communication device 105 participating in a push-to-talk transmission (e.g., both transmitting audio and receiving audio) transmits RSSI information to the fixed network equipment 115 through a separate channel than the channel used for audio communication. In some instances, the second electronic processor 305 selects the lowest RSSI value associated with communication devices 105 in the talkgroup 120. In yet another instance, the second electronic processor 305 calculates an average RSSI value using the received RSSI values from each communication device 105 in the talkgroup 120.

At block 610, the second electronic processor 305 determines a vocoder data rate and an error correction data rate for a subsequent push-to-talk transmission based on the RSSI value from each communication device 105. For example, the second electronic processor 305 may compare the RSSI value to a look-up table stored in the second memory 310.

At block 615, the second electronic processor 305 transmits the determined vocoder data rate and the determined error correction data rate to each communication device 105 in the talkgroup 120 participating in the push-to-talk transmission to be implemented in a subsequent push-to-talk transmission. Accordingly, while the talkgroup 120 is in a push-to-talk transmission, the communication device 105 transmit updated channel condition information to the fixed network equipment 115. The fixed network equipment 115 transmits updated vocoder and error correction data rates to be utilized during future, subsequent push-to-talk transmissions.

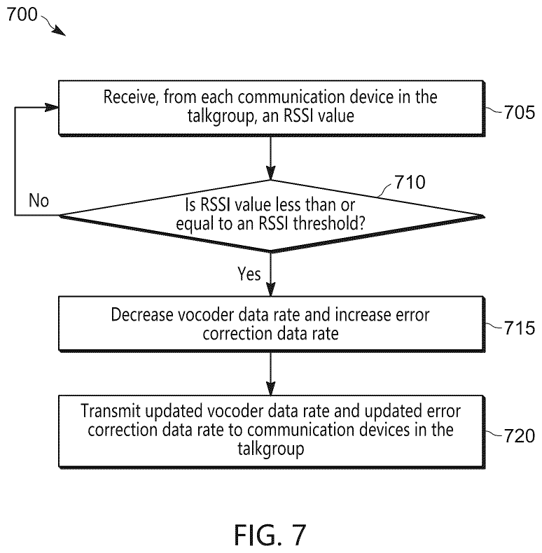

In some instances, operators of the communication devices 105 may move during or between push-to-talk transmissions, altering the coverage of the respective communication device 105. FIG. 7 illustrates an example method 700 of adapting data rates for push-to-talk transmissions based on a RSSI value of a talkgroup 120. The method 700 is described as being executed by the fixed network equipment 115 and, in particular, by the second electronic processor 305. However, in some examples, the method 700 is performed by another device (for example, another computer or one of the communication devices 105). Additionally, while the process blocks illustrated in FIG. 7 provide one example of a method described herein, it is understood that some blocks may be removed, added, combined, reordered, or modified without departing from the spirit of the present disclosure.

At block 705, the second electronic processor 305 receives, from each communication device 105 included in the talkgroup 120, an RSSI value. For example, each communication device 105 transmits an associated RSSI value to the fixed network equipment 115 prior to, upon initiation of, or during a push-to-talk transmission. In some instances, the second electronic processor 305 selects a lowest RSSI value among the RSSI values received from the communication devices 105 in the talkgroup 120. In other instances, the second electronic processor 305 determines an average RSSI value using the RSSI values received from the communication devices 105 in the talkgroup 120.

At block 710, the second electronic processor 305 determines whether the RSSI value is less than or equal to an RSSI threshold. For example, the fixed network equipment 115 compares the RSSI value to an RSSI threshold. When the RSSI value is greater than the threshold, the second electronic processor 305 responsively returns to block 705. When the RSSI value is less than or equal to the RSSI threshold, the second electronic processor 305 proceeds to block 715.

At block 715, the second electronic processor 305 decreases the vocoder data rate and increases the error correction data rate. For example, communication devices 105 may have entered an area with less coverage than when the vocoder and error correction data rates were previously set. Responsive to the communication devices 105 having less coverage, the second electronic processor 305 decreases the vocoder data rate below a default vocoder data rate and increases the error correction data rate above a default error correction date rate, dedicating more bandwidth to error correction and potentially offsetting the decrease in coverage.

At block 720, the second electronic processor 305 transmits the updated vocoder data rate and the updated error correction data rate to the communication devices 105 in the talkgroup 120.

In some instances, the communication device 105 may return to an area having increased coverage, and the RSSI values reported by the talkgroup 120 may increase above the RSSI threshold. When the RSSI values reported by the talkgroup 120 increase above the RSSI threshold, the fixed network equipment 115 may responsively increase the vocoder data rate and decrease the error correction data rate, returning the vocoder data rate and the error correction data rate to their previous values (e.g., the default values).

While the method 500 of FIG. 5, the method 600 of FIG. 6, and the method 700 of FIG. 7 primarily reference the RSSI values reported by communication devices 105, these methods may also apply to other measures of coverage and noise experienced by the communication devices 105, such as BER, SNR, or some other channel condition metric or audio quality metric.

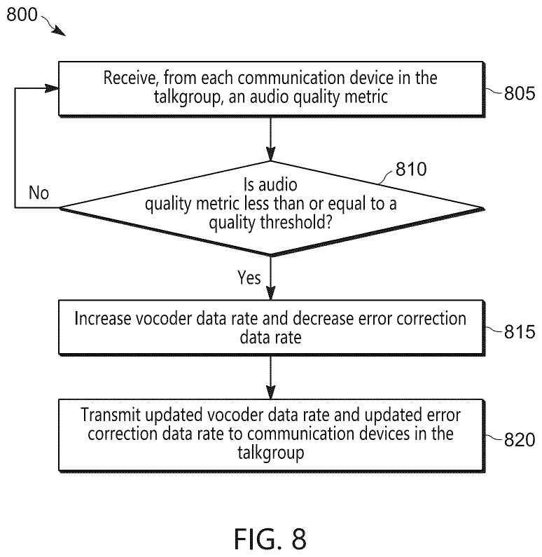

Similarly, in some instances, operators of the communication devices 105 may move during or between push-to-talk transmissions to areas with high noise. FIG. 8 illustrates an example method 800 of adapting data rates for push-to-talk transmissions based on an audio quality metric of a talkgroup 120. The method 800 is described as being executed by the fixed network equipment 115 and, in particular, by the second electronic processor 305. However, in some examples, the method 800 is performed by another device (for example, another computer or one of the communication devices 105). Additionally, while the process blocks illustrated in FIG. 8 provide one example of a method described herein, it is understood that some blocks may be removed, added, combined, reordered, or modified without departing from the spirit of the present disclosure.

At block 805, the second electronic processor 305 receives, from each communication device 105 in a talkgroup 120, an audio quality metric. For example, a communication device 105 enters an area with high audio noise. The high audio noise is reflected in an audio quality metric reported from the communication device 105 to the fixed network equipment 115. In some instances, the second electronic processor 305 selects the lowest (e.g., worst) audio quality metric among the audio quality metrics received from the communication devices 105 in the talkgroup 120. In other instances, the second electronic processor 305 determines an average audio quality metric using the audio quality metrics received from the communication devices 105 in the talkgroup 120.

At block 810, the second electronic processor 305 determines whether the audio quality metric is less than or equal to a quality threshold. For example, the fixed network equipment 115 compares the audio quality metric to the quality threshold. When the audio quality metric is greater than the quality threshold, the second electronic processor 305 responsively returns to block 805. When the audio quality metric is less than or equal to the quality threshold, the second electronic processor 305 responsively proceeds to block 815.

At block 815, the second electronic processor 305 increases the vocoder data rate and decreases the error correction data rate. For example, communication devices 105 may have entered an area with increased noise than when the vocoder and error correction data rates were previously set. Responsive to the communication devices 105 experiencing increased noise, the second electronic processor 305 increases the vocoder data rate from a default vocoder data rate and decreases the error correction data rate from a default error correction data rate, dedicating more bandwidth to audio transmission and potentially offsetting the increased noise.

At block 820, the second electronic processor 305 transmits the updated vocoder data rate and the updated error correction data rate to the communication devices 105 in the talkgroup 120.

In some instances, the communication device 105 may return to an area having decreased noise, and the audio quality metrics reported by the talkgroup 120 may increase above the quality threshold. When the audio quality metrics reported by the talkgroup 120 increase above the quality threshold, the fixed network equipment 115 may responsively decrease the vocoder data rate and increase the error correction data rate, returning the vocoder data rate and the error correction data rate to their previous values.

In some aspects, the fixed network equipment 115 determines the vocoder data rate and the error correction data rate based on characteristics of the communication device 105 beyond coverage and audio quality information. For example, the vocoder data rate and the error correction data rate may be determined based on a location of one or more communication devices 105, based on user roles of one or more communication devices 105, based on priority values assigned to the communication devices 105, or the like.

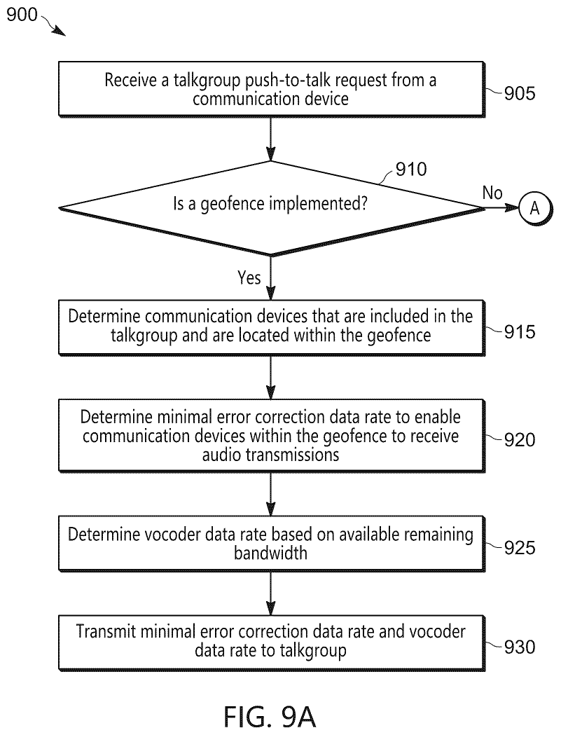

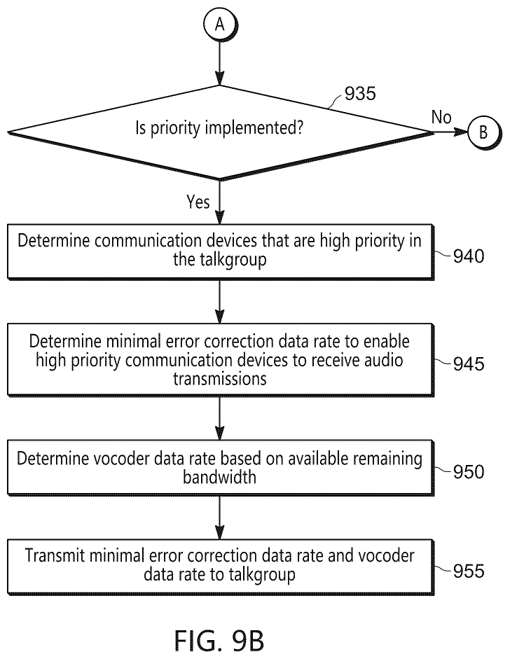

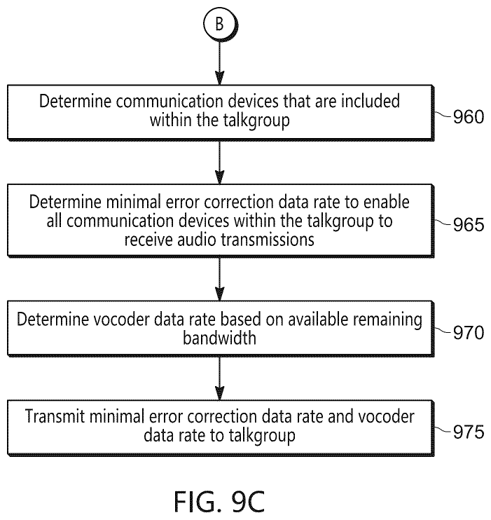

FIGS. 9A-9C illustrate an example method 900 of adapting data rates for push-to-talk transmissions within a talkgroup 120. The method 900 is described as being executed by the fixed network equipment 115 and, in particular, by the second electronic processor 305. However, in some examples, the method 900 is performed by another device (for example, another computer or one of the communication devices 105). Additionally, while the process blocks illustrated in FIGS. 9A-9C provide one example of a method described herein, it is understood that some blocks may be removed, added, combined, reordered, or modified without departing from the spirit of the present disclosure.

Beginning in FIG. 9A, at block 905, the second electronic processor 305 receives a talkgroup push-to-talk request from a communication device 105. For example, a user of the first communication device 105A presses the push-to-talk mechanism 235 to initiate a push-to-talk transmission. In response, the communication device 105 transmits a talkgroup push-to-talk request to the fixed network equipment 115 indicating the incoming push-to-talk transmission.

At block 910, the second electronic processor 305 determines whether a geofence is implemented. For example, a geofence may be assigned to a location to indicate poor coverage within a given area. Accordingly, when a communication device 105 is detected as entering a geofence, the fixed network equipment 115 determines that the communication device 105 is entering an area with poor coverage. In another example, a geofence may be an identified area surrounding a public safety incident. Accordingly, the geofence may indicate an area where communication is important or relevant. When a geofence is being implemented, the second electronic processor 305 proceeds to block 915. When a geofence is not being implemented, the second electronic processor 305 may proceed to block 935 (see FIG. 9B).

At block 915, the second electronic processor 305 determines which communication devices 105 within a talkgroup 120 are located within the geofence. For example, alongside channel condition information, the communication devices 105 may transmit location information (for example, via Global Positioning Services [GPS] or some other location-based service). The location information may be transmitted by the communication device 105 to the fixed network equipment 115 while the communication device 105 is idle (for example, not participating in a push-to-talk transmission), upon initiation of a push-to-talk transmission, or during a push-to-talk transmission. In some implementation, the second electronic processor 305 stores a most recent location of each communication device 105 within the second memory 310. The second electronic processor 305 then retrieves the most recent location of the communication devices 105 within the talkgroup 120. After receiving the location of each communication device 105, the fixed network equipment 115 determines whether the location of each communication device 105 is within a geofence.

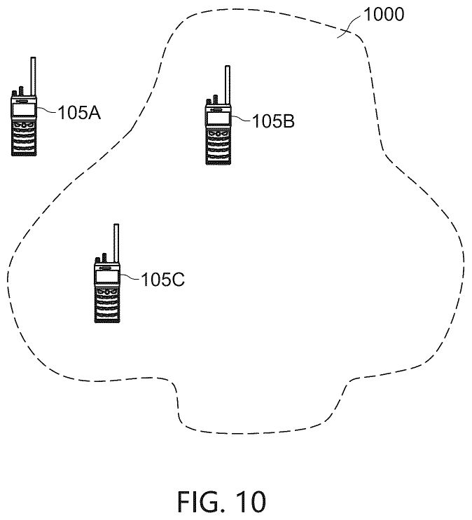

FIG. 10 illustrates an example geofence 1000 in which multiple communication devices 105 are situated. Particularly, in the example of FIG. 10, the first communication device 105A is not within the geofence 1000, and the second communication device 105B and the third communication device 105C are within the geofence 1000. Accordingly, the first communication device 105A may have good (or satisfactory) coverage for transmitting audio. The second communication device 105B and the third communication device 105C may have poor coverage for transmitting audio. Alternatively, in a situation where the geofence indicates an area of a public safety incident, the second communication device 105B and the third communication device 105C are within the geofence 1000 and are in an area where communication of the second communication device 105B and the third communication device 105C should be prioritized.

Returning to FIG. 9A, at block 920, the second electronic processor 305 determines a minimal error correction data rate to enable communication devices 105 that are located within the geofence to receive audio transmission. In some instances, the minimal error correction data rate is calculated based on channel condition information. The channel condition information may be a metric based on the RSSI, the BER, the SNR, or a combination thereof that are communicated by the communication devices 105 to the fixed network equipment 115.

At block 925, the second electronic processor 305 determines a vocoder data rate based on an available remaining bandwidth. For example, after the minimal error correction data rate is determined, the remaining bandwidth is assigned to the vocoder data rate for audio transmission.

At block 930, the second electronic processor 305 transmits the minimal error correction data rate and the vocoder data rate to the talkgroup 120. In this manner, the fixed network equipment 115 sets the vocoder data rate and the error correction data rate such that the second communication device 105B and the third communication device 105C, which are within the geofence, are capable of participating in push-to-talk transmissions.

Referring now to FIG. 9B, at block 935, the second electronic processor 305 determines whether priority values are implemented. For example, priority values may be assigned to the communication devices 105. Priority values may be based on user roles. For example, in a public safety setting, the communication device 105 of a sheriff may have a higher priority value that a police officer. Similarly, in a fire fighting setting, a fire chief may have a higher priority value than a firefighter. When such priority values are implemented, the second electronic processor 305 proceeds to block 940. When priority values are not implemented, the second electronic processor 305 proceeds to block 960 (see FIG. 9C).

At block 940, the second electronic processor 305 determines whether any communication devices 105 in the talkgroup 120 are a high priority device. As one example, devices may be assigned three priority tiers: Low Priority (e.g., a 1), Mid Priority (e.g., a 2), and High Priority (e.g., a 3). Should any of the communication device 105 within the talkgroup 120 have a priority value greater than or equal to a priority threshold (for example, a 2), then the communication device 105 is considered a high priority device.

At block 945, the second electronic processor 305 determines a minimal error correction data rate to enable the high priority communication devices 105 in the talkgroup 120 to receive audio transmission. In some instances, the minimal error correction data rate is calculated based on channel condition information. The channel condition information may be a metric based on the RSSI, the BER, the SNR, or a combination thereof that are communicated by the communication devices 105 to the fixed network equipment 115.

At block 950, the second electronic processor 305 determines the vocoder data rate based on an available remaining bandwidth. For example, after the minimal error correction data rate is determined, the remaining bandwidth is assigned to the vocoder data rate for audio transmission.

At block 955, the second electronic processor 305 transmits the minimal error correction data rate and the vocoder data rate to the talkgroup 120.

Referring now to FIG. 9C, at block 960, the second electronic processor 305 determines which communication devices 105 are included within the talkgroup 120. For example, the second electronic processor 305 may store and periodically update a lookup table within the second memory 310 that indicates which communication devices 105 are included in which talkgroup 120.

At block 965, the second electronic processor 305 determines a minimal error correction data rate to enable all communication devices 105 within the talkgroup 120 to receive audio transmissions. In some instances, the minimal error correction data rate is calculated based on channel coverage information. The channel coverage information may be a metric based on the RSSI, the BER, the SNR, or a combination thereof that are communicated by the communication devices 105 to the fixed network equipment 115.

At block 970, the second electronic processor 305 determines the vocoder data rate based on an available remaining bandwidth. For example, after the minimal error correction data rate is determined, the remaining bandwidth is assigned to the vocoder data rate for audio transmission.

At block 975, the second electronic processor 305 transmits the minimal error correction data rate and the vocoder data rate to the talkgroup 120.

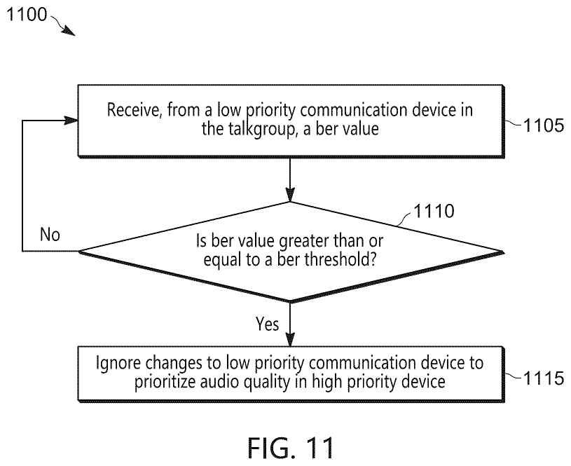

In examples where priority values are implemented, the fixed network equipment 115 may prioritize high priority communication devices 105 in the talkgroup 120 while ignoring updates from low priority communication devices 105. FIG. 11 illustrates an example method 1100 of adapting data rates for push-to-talk transmissions based on a priority value of communication devices 105 within a talkgroup 120. The method 1100 is described as being executed by the fixed network equipment 115 and, in particular, by the second electronic processor 305. However, in some examples, the method 1100 is performed by another device (for example, another computer or one of the communication devices 105). Additionally, while the process blocks illustrated in FIG. 11 provide one example of a method described herein, it is understood that some blocks may be removed, added, combined, reordered, or modified without departing from the spirit of the present disclosure.

At block 1105, the second electronic processor 305 receives, from a low priority communication device 105 in the talkgroup 120, a BER value. For example, each communication device 105 (including low priority communication devices 105) transmits an associated BER value to the fixed network equipment 115 prior to, upon initiation of, or during a push-to-talk transmission.

At block 1110, the second electronic processor 305 determines whether the BER value is greater than or equal to a BER threshold. For example, the fixed network equipment 115 compares the BER value to a BER threshold. When the BER value is less than the threshold, the second electronic processor 305 responsively returns to block 1105. When the BER value is greater than or equal to the BER threshold, the second electronic processor 305 proceeds to block 1115.

At block 1115, the second electronic processor 305 ignores changes to the low priority communication device 105 to prioritize audio quality in the high priority device. For example, a low priority communication device 105 may enter an area with low coverage or high noise, increasing the BER of the low priority communication device 105. However, the fixed network equipment 115 may only update the vocoder data rate and the error correction data rate based on updated channel condition information from a high priority communication device. While the method 1100 refers to the BER as an example, other characteristics of channel condition information may instead be implemented within the method 1100.

In the foregoing specification, various embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. For example, it should be understood that although certain drawings illustrate hardware and software located within particular devices, these depictions are for illustrative purposes only. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Additionally, methods described herein are not limited to being performed independently, and at least some blocks performed by each method may be combined with another method.

The benefits, advantages, solutions to problems, and any element(s) that may cause any benefit, advantage, or solution to occur or become more pronounced are not to be construed as a critical, required, or essential features or elements of any or all the claims.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

We claim:

1. A fixed network device that communicates with push-to-talk portable electronic devices via a communication network, the fixed network device comprising:
an electronic processor configured to, for each push-to-talk transmission of the portable electronic devices:
receive a push-to-talk transmission request from a first portable electronic device,
determine a set of the portable electronic devices within a talkgroup participating in the requested push-to-talk transmission,
determine, based on a characteristic of the talkgroup, a vocoder data rate and a forward error correction coding data rate for the requested push-to-talk transmission, and
transmit the determined vocoder data rate and the determined forward error correction coding data rate to the set of portable electronic devices within the talkgroup.

2. The fixed network device of claim 1, wherein the electronic processor is further configured to, for each push-to-talk transmission of the portable electronic devices:
receive, during the push-to-talk transmission, an updated characteristic of the talkgroup, and
determine, based on the updated characteristic, an updated vocoder data rate and an updated forward error correction coding data rate.

3. The fixed network device of claim 2, wherein the electronic processor is further configured to:
receive a second push-to-talk transmission request from the first portable electronic device, and
transmit, in response to the second push-to-talk transmission request, the updated vocoder data rate and the updated forward error correction coding data rate to the set of portable electronic devices within the talkgroup.

4. The fixed network device of claim 1, wherein the characteristic of the talkgroup is a received channel condition information of the talkgroup, wherein the channel condition information includes at least one selected from the group consisting of a RSSI value and a BER value, and wherein, to determine the vocoder data rate and the forward error correction coding data rate for the requested push-to-talk transmission, the electronic processor is configured to:
compare the channel condition information to a quality threshold,
decrease, in response to the channel condition information being less than the quality threshold, the vocoder data rate below a default vocoder data rate, and
increase, in response to the channel condition information being less than the quality threshold, the forward error correction coding data rate above a default forward error correction coding data rate.

5. The fixed network device of claim 4, wherein, to determine the vocoder data rate and the forward error correction coding data rate for the requested push-to-talk transmission, the electronic processor is configured to:
increase, in response to the channel condition information being greater than or equal to the quality threshold, the vocoder data rate, and
decrease, in response to the channel condition information being greater than or equal to the quality threshold, the forward error correction coding data rate.

6. The fixed network device of claim 1, wherein the characteristic of the talkgroup is a speech signal-to-noise ratio (SNR) of the talkgroup, and wherein, to determine the vocoder data rate and the forward error correction coding data rate for the requested push-to-talk transmission, the electronic processor is configured to:
compare the SNR to a quality threshold,
increase, in response to the SNR being less than the quality threshold, the vocoder data rate above a default vocoder data rate, and
decrease, in response to the SNR being less than the quality threshold, the forward error correction coding data rate below a default forward error correction coding data rate.

7. The fixed network device of claim 6, wherein, to determine the vocoder data rate and the forward error correction coding data rate for the requested push-to-talk transmission, the electronic processor is configured to:
decrease, in response to the SNR being greater than or equal to the quality threshold, the vocoder data rate, and
increase, in response to the SNR being greater than or equal to the quality threshold, the forward error correction coding data rate below a default forward error correction coding data rate.

8. The fixed network device of claim 1, wherein the characteristic of the talkgroup is a location of the portable electronic devices within the talkgroup.

9. The fixed network device of claim 8, wherein, to determine the vocoder data rate and the forward error correction coding data rate for the requested push-to-talk transmission, the electronic processor is configured to:
determine, based on the location of the portable electronic devices within the talkgroup, a minimal forward error correction coding data rate to enable audio transmission between the portable electronic devices within the talkgroup; and
determine, based on a remaining available bandwidth after determining the minimal forward error correction coding data rate, the vocoder data rate.

10. The fixed network device of claim 1, wherein the characteristic is a priority value associated with the portable electronic devices within the talkgroup.

11. The fixed network device of claim 10, wherein, to determine the vocoder data rate and the forward error correction coding data rate for the requested push-to-talk transmission, the electronic processor is configured to:
determine whether at least one of the priority values associated with the portable electronic devices within the talkgroup is greater than a priority threshold;
determine, based on the at least one of the priority values being greater than the priority threshold, a minimal forward error correction coding data rate to enable audio transmission for at least one high priority portable electronic devices associated with the at least one of the priority values being greater than the priority threshold; and
determine, based on a remaining available bandwidth after determining the minimal forward error correction coding data rate, the vocoder data rate.

12. A method for adapting data rates for push-to-talk transmissions, the method, for each push-to-talk transmission, comprising:
receiving a push-to-talk transmission request from a first portable electronic device;
determining a set of portable electronic devices within a talkgroup participating in the requested push-to-talk transmission;
determining, based on a characteristic of the talkgroup, a vocoder data rate and a forward error correction coding data rate for the requested push-to-talk transmission; and
transmitting the determined vocoder data rate and the determined forward error correction coding data rate to the set of portable electronic devices within the talkgroup.

13. The method of claim 12, further comprising:
receiving, during the push-to-talk transmission, an updated characteristic of the talkgroup; and
determining, based on the updated characteristic, an updated vocoder data rate and an updated forward error correction coding data rate.

14. The method of claim 13, further comprising:
receiving a second push-to-talk transmission request from the first portable electronic device; and
transmitting, in response to the second push-to-talk transmission request, the updated vocoder data rate and the updated forward error correction coding data rate to the set of portable electronic devices within the talkgroup.

15. The method of claim 12, wherein the characteristic of the talkgroup is a received signal strength indicator (RSSI) of the talkgroup, and wherein determining the vocoder data rate and the forward error correction coding data rate for the requested push-to-talk transmission includes:
comparing the RSSI to a quality threshold,
decreasing, in response to the RSSI being less than the quality threshold, the vocoder data rate below a default vocoder data rate, and
increasing, in response to the RSSI being less than the quality threshold, the forward error correction coding data rate above a default forward error correction coding data rate.

16. The method of claim 15, wherein determining the vocoder data rate and the forward error correction coding data rate for the requested push-to-talk transmission includes:
increasing, in response to the RSSI being greater than or equal to the quality threshold, the vocoder data rate, and
decreasing, in response to the RSSI being greater than or equal to the quality threshold, the forward error correction coding data rate.

17. The method of claim 12, wherein the characteristic of the talkgroup is a speech signal-to-noise ratio (SNR) of the talkgroup, and wherein determining the vocoder data rate and the forward error correction coding data rate for the requested push-to-talk transmission includes:
comparing the SNR to a quality threshold,
increasing, in response to the SNR being less than the quality threshold, the vocoder data rate above a default vocoder data rate, and
decreasing, in response to the SNR being less than the quality threshold, the forward error correction coding data rate below a default forward error correction coding data rate.

18. The method of claim 17, wherein determining the vocoder data rate and the forward error correction coding data rate for the requested push-to-talk transmission includes:
decreasing in response to the SNR being greater than or equal to the quality threshold, the vocoder data rate, and
increasing, in response to the SNR being greater than or equal to the quality threshold, the forward error correction coding data rate below a default forward error correction coding data rate.

19. The method of claim 12, wherein the characteristic of the talkgroup is a location of the portable electronic devices within the talkgroup, and wherein determining the vocoder data rate and the forward error correction coding data rate for the requested push-to-talk transmission includes:
determining, based on the location of the portable electronic devices within the talkgroup, a minimal forward error correction coding data rate to enable audio transmission between the portable electronic devices within the talkgroup; and
determining, based on a remaining available bandwidth after determining the minimal forward error correction coding data rate, the vocoder data rate.

20. The method of claim 12, wherein the characteristic is a priority value associated with the portable electronic devices within the talkgroup, and wherein determining the vocoder data rate and the forward error correction coding data rate for the requested push-to-talk transmission includes:
determining whether at least one of the priority values associated with the portable electronic devices within the talkgroup is greater than a priority threshold;
determining, based on the at least one of the priority values being greater than the priority threshold, a minimal forward error correction coding data rate to enable audio transmission for at least one high priority portable electronic devices associated with the at least one of the priority values being greater than the priority threshold; and
determining, based on a remaining available bandwidth after determining the minimal forward error correction coding data rate, the vocoder data rate.
